(19) United States
(12) Patent Application Publication
(10) Pub. No.: US 2022/0147840 A1
(43) Pub. Date: May 12, 2022

(54) DOMAIN KNOWLEDGE DETERMINATION

(71) Applicant: Hewlett-Packard Development Company, L.P., Spring, TX (US)

(72) Inventors: Rafael Dal Zotto, Porto Alegre (BR); John Landry, Spring, TX (US)

(73) Assignee: Hewlett-Packard Development Company, L.P., Spring, TX (US)

(21) Appl. No.: 17/418,799

(22) PCT Filed: Jul. 31, 2019
(86) PCT No.: PCT/US2019/044345

§ 371 Date: Jun. 26, 2021

(51) Int. Cl. G06N 5/02; G06F 11/34

(52) U.S. Cl. CPC G06N 5/022; G06F 11/3438

(57) ABSTRACT

Example implementations relate to determining user domain knowledge. An example non-transitory machine-readable medium can include instructions executable by a processor to retrieve from a provider on a computing device telemetry data associated with a user of the computing device, map user domain knowledge relationships based on the retrieved telemetry data and determine a domain knowledge of the user based on the mapped relationships.

### BACKGROUND

Device management includes configuring and deploying applications to computing devices with a network (e.g., an organization network) such as personal computers (PCs), laptops, desktops, workstations, and mobile devices. Device management can include providing centralized control of the computing devices.

### BRIEF DESCRIPTION OF THE DRAWINGS

FIG. 1 illustrates a system for determining user domain knowledge including a controller, computing devices, and providers according to an example;

FIG. 2 illustrates a mapping of user application usage according to an example;

FIG. 3 illustrates a mapping of user domain knowledge according to an example;

FIG. 4 illustrates a mapping of user application usage and domain knowledge according to an example;

FIG. 5 illustrates a method for determining user domain knowledge according to an example;

FIG. 6 illustrates another system for determining user domain knowledge including a processor and a non-transitory machine-readable medium (MRM); and

FIG. 7 illustrates another method for determining user domain knowledge according to an example.

### DETAILED DESCRIPTION

As device management evolves, fleet-managers (e.g., administrators) may desire to collect specific data such as telemetry or configuration data about computing devices and the computing device environment. For instance, the data can include operating system (OS) data, application data, hardware configuration data, peripheral data; communication data, or usability data, among others. The data, for instance, may be used to drive automation processes of a device management controller, test end user assumptions, feed analytical curiosity of end users, confirm computing device user behaviors, or drive decision points for end users. As used herein, a computing device can be a mechanical or electrical device that transmits or modifies energy to perform or assist in the performance of human tasks. Examples include thin clients, personal computers, printing devices; laptops, tablets, smartphones, mobile devices, and gaming consoles, among others.

In some examples of the present disclosure, device management can include determining a domain knowledge of a user of a computing device using telemetry data collected by a provider on an associated computing device. For instance, the user's domain knowledge, which may also be referred to as subject-matter expertise, can be determined, processed, and organized. The user's domain knowledge can be correlated and mapped with other users' domain knowledge, allowing for an organization to dynamically view and update employees' domain knowledges and match those domain knowledges with subject matter area assignments in the organization, for instance.

Some approaches to collecting domain knowledges of users include collecting information from users at the time of employment. For instance, a human resources employee may collect a new hire's educational and previous work experience and file the information. This information may not be updated unless the user chooses to do so or responds to a request for updating. Other approaches base users' domain knowledges on time spent with an organization, timesheets, calendar events, or titles in the organization, among others. Such approaches do not allow for tracking of dynamic data associated with the user and organizational mapping of different users' domain knowledges.

In contrast, examples of the present disclosure provide for collection of application and communication data from a plurality of computing devices (or a single computing device) to gain insights about domain knowledge of a user or users within an organization. For instance, some examples allow for periodic or near-continuous collection, by a provider on a computing device, of telemetry data associated with an amount of time a user spends interacting with particular applications and telemetry data associated with subject-matter content in the applications and/or in communications of the user. In some examples, more than one provider on the computing device collects the telemetry data. Using this information, a user's domain knowledge can be determined. The provider can be embedded in the computing device such that it is nonintrusive. The provider may be pre-configured on the computing device, sent through a management framework, or installed manually, among others. Such data can be sent to a controller (e.g., a server) periodically (e.g., scheduled) or near-continuously (e.g., in real time), such that the computing device is constantly monitored by the provider, and any data changes/updates are sent responsive to detection of the change/update.

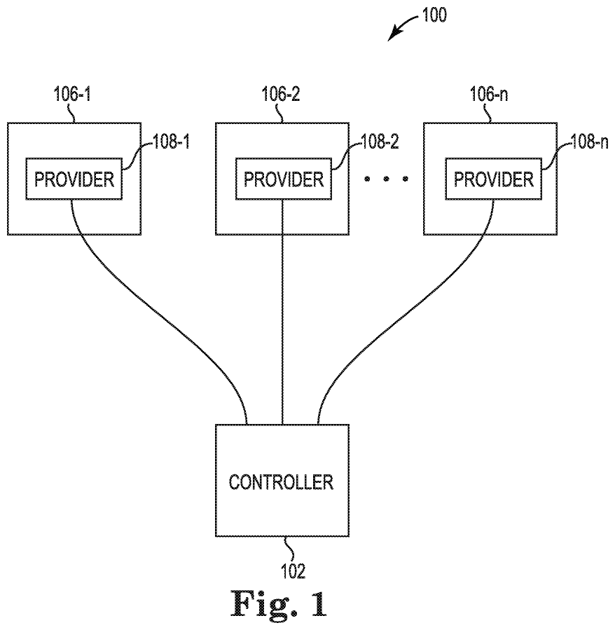

FIG. 1 illustrates a system 100 for determining user domain knowledge including a controller 102, computing devices 106-1, 106-2, . . . , 106-n (referred to herein after collectively as computing devices 106), and providers 108-1, 108-2, 108-n (referred to herein after collectively as providers 108) according to an example. The providers 108 can be housed (e.g., deployed, embedded, etc.) on a different one of a plurality of associated computing devices 106. The controller 102 can be communicatively coupled to computing devices 106, providers 108, and/or a graphical user interface (GUI) in some examples. As used herein, “communicatively coupled” can include coupled via various wired and/or wireless connections between devices such that data can be transferred in various directions between the devices. The coupling need not be a direct connection, and in some examples, can be an indirect connection. The controller 102 can be responsible for deploying tasks (e.g., requests for monitoring particular applications or communications from particular computing devices) to individual computing devices 106 for execution and gathering of responses to those tasks. For instance, the controller can deploy instructions to the providers 108 to perform the monitoring for a particular application or communication, and the controller 102 can retrieve and compile notifications from the providers 108. In some examples, the provider 108 can monitor a plurality of applications and/or communications, such that insights may be gained with respect to how users use each one of the plurality of applications, as well as the users' associated domain knowledges. While one provider 108 per computing device 106 is illustrated in FIG. 1, more than one provider 108 may be present and collecting telemetry data on each computing device 106.

The providers 108 can collect from an associated computing device 106 application telemetry data and/or communication telemetry data associated with a user of the associated computing device 106. Application data, as used herein includes data produced when a user is using an application (e.g., word processing, web development tool, spreadsheet, etc.) including an amount of time spent interacting with the application. Communication data, as used herein includes data obtained from inspections executed on top of text contents exchanged during use of the applications, for instance using an artificial intelligence (AI) model. For instance, the communication data may come from email communication, instant messaging, word processing, integrated development environments (IDES), etc.

The telemetry data can be monitored and/or collected periodically (e.g., scheduled) or near-continuously (e.g., in real time), and can periodically or near-continuously report the collected telemetry data to the controller 102. As used herein, near-continuously includes monitoring, collecting, reporting, etc. without meaningful breaks. For example, the provider 108 may communicate with the controller 102 only when telemetry data associated with a pre-determined application, tool, or domain is detected, while in other examples, the provider 108 communicates with the controller 102 in accordance with a predetermined schedule (e.g., hourly, daily, weekly, etc.).

In some examples, the monitoring and notification is performed iteratively. For instance, the monitoring and notification does not end when a single pre-determined usage is detected. Rather, the monitoring can be near-continuous such that the computing device is near-continuously monitored until instructions come to cease monitoring. For instance, the computing devices 106 can be near-continuously monitored for application or tool usage of a particular type with notifications sent to the controller 102 with each usage detected. This process can be iterative such that the monitoring and notification continues until an outside source stops it (e.g., an administrator ceases the monitoring, a power outage, etc.).

The controller 102, in some examples, can include a processor, a memory resource, and/or engines. For instance, the controller 102 can be a combination of hardware and instructions for determining user domain knowledge. The hardware, for example can include the processor and/or the memory resource (e.g., machine-readable medium (MRM), computer-readable medium (CRM), data store, etc.).

The processor, as used herein, can include a number of processing resources capable of executing instructions stored by the memory resource. The instructions (e.g., machine-readable instructions (MRI)) can include instructions stored on the memory resource and executable by the processor to implement a desired function (e.g., determining user domain knowledge). The memory resource, as used herein, can include a number of memory components capable of storing non-transitory instructions that can be executed by the processor. The memory resource can be integrated in a single device or distributed across multiple devices. Further, the memory resource can be fully or partially integrated in the same device as the processor or it can be separate but accessible to that device and processor. Thus, it is noted that the controller can be implemented on an electronic device and/or a collection of electronic devices, among other possibilities.

The memory resource can be in communication with the processor via a communication link (e.g., path). The communication link can be local or remote to an electronic device associated with the processor. The memory resource includes engines, and the engines can include a combination of hardware and instructions to perform a number of functions described herein (e.g., determining user domain knowledge). The instructions (e.g., software, firmware, etc.) can be downloaded and stored in a memory resource (e.g., MRM) as well as a hard-wired program (e.g., logic), among other possibilities. In some examples, the engines may be composed on separate computing systems.

In some examples, the controller can determine a knowledge level of each one of the users with respect to each one of a plurality of applications of the plurality of application data. For instance, a knowledge level with respect to an application refers to a user's proficiency in the application. This can be determined, for example, based on experience a user has with the application (e.g., time spent interacting with the application), and/or can be associated with a particular domain. For instance, a user may spend a given amount of time interacting with a particular application about a particular domain (e.g., subject matter). A first user may have a higher application knowledge level associated with a particular domain as compared to a second user if the first user has more experience using the particular application in the particular domain as compared to the second user. In some examples, AI models may be used to determine knowledge levels. Such state-of-the-art models can be used for inference using cloud-based or edge-based approaches.

In some instances, the controller can determine a domain knowledge of each one of the users of the respective one of the plurality of computing devices based on the knowledge levels. For example, once it is determined how long a user has interacted with an application or applications for particular domains, a domain knowledge can be determined. For instance, if a user uses applications A, B, and C, and the majority of the time spent interacting with those applications is related to domain B, it may be determined that the user has a domain knowledge in domain B. If the user has more experience with domain B than a different user, it may be determined that the user has a greater domain knowledge in domain B than the different user.

In some examples, communication data can be used in a determination of a domain knowledge and/or a knowledge level. Communication data can include content retrieved from monitoring communications exchanged through the use of the applications and tools. For instance, communication data can be gathered via inspections executed on top of text contents of the communications (e.g., email, instant messaging, word processing, IDEs, etc.). By combining and correlating the communication data with the application data, knowledge levels and domain knowledges can be determined.

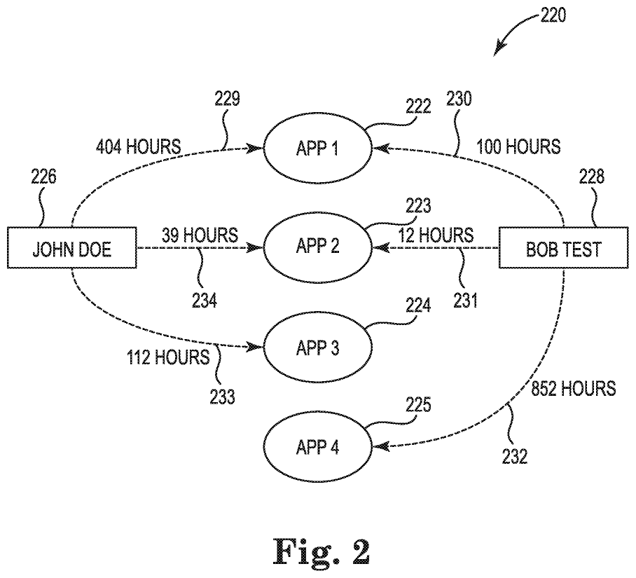

In some examples, domain knowledge relationships between different users of the plurality of computing devices based on the determined knowledge levels and determined domain knowledges can be determined. For example, it may be determined that certain users overlap domain knowledges or use related applications. In some example, the determined domain knowledge relationships can be mapped, and these mappings, as discussed with respect to FIGS. 2-4 can be used to determine insights regarding users and their domain knowledges. The mappings, for example, can include a graph created upon gathering of the telemetry data and/or may include results from AI models executed against the telemetry data. Such insights gathered from the mappings can be used to make hiring decisions, reorganize a workforce for a specific (e.g., new) initiative, or assign tasks, for instance.

FIG. 2 illustrates a mapping 220 of user application usage according to an example. For instance, users, such as John Doe at 226 and Bob Test at 228 use applications and tools to perform their tasks. In some examples, the applications in use, as well as how much time the user spent interacting with each application are captured by a provider located on the user's computing device. By doing so, usage statistics can be gathered while using the applications and tools with which the user is familiar, and the amount of time associated with the use of the tools and the applications. The total time the user interacted with a particular application may be used to determine a knowledge level (e.g., expertise, experience time, etc.).

The mapping 220 illustrates that user John Doe 226 has interacted with a first application 222 for 404 hours, a second application 223 for 39 hours, and a third application 224 for 112 hours, as shown at 229, 234, and 233 respectively. The mapping 220 illustrates that John Doe 226 has not interacted with a fourth application 225. User Bob Test 228 has interacted with the first application 222 for 100 hours, the second application 223 for 12 hours, and the fourth application 225 for 852 hours, as shown at 230, 231, and 232 respectively. The mapping 220 illustrates that Bob Test 228 has not interacted with the third application 224. Using the mapping, insights may be gained, for instance, that Bob Test 228 has a higher knowledge level with respect to the fourth application 225 as compared to John Doe 226, while John Doe 226 has a higher knowledge level with respect to the first application 222, the second application 223, and the third application 224 as compared to Bob Test 228.

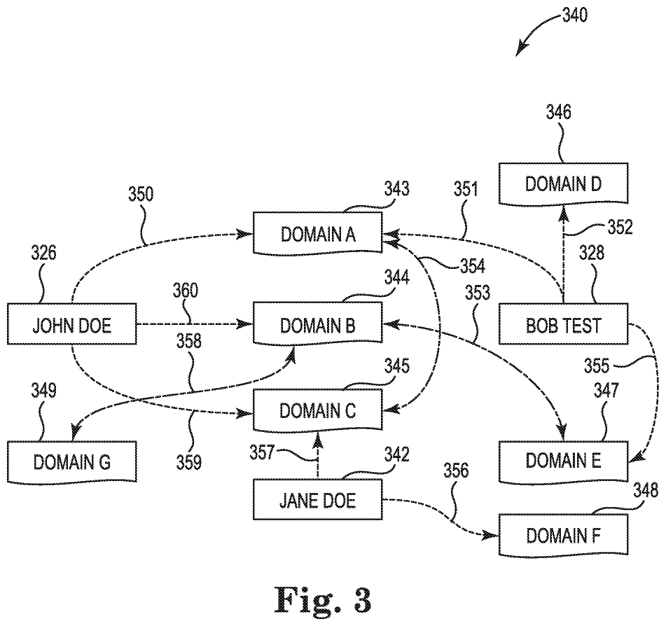

FIG. 3 illustrates a mapping 340 of user domain knowledge according to an example. The applications in use can indicate with what tools each user is familiar, but the tools may be used in different ways. For instance, the way a user uses a tool can identify a domain with which a user is familiar. How the user interacts with an application and/or tool and what type of content is inserted or used against each application can be tracked. For instance, a word processing application can be used to create reports about plants and botanical information, but it can also be used to produce financial reports. The word processing tool in the word processing application is the same, but the users that are using the tool have different domain knowledges. Some examples can track, for instance using a provider on a computing device, content added to a particular tool and determine insights and relationships from the content. For instance, text in a word processing application can be collected, from different contexts, to identify domain knowledge from it to be used to map user domain knowledge, as shown in the mapping 340. This can be done, for instance, using state-of-the art AI models and techniques.

The mapping 340 is based on identified domain knowledges of users John Doe 326, Bob Test 328, and Jane Doe 342. Mapping 340 includes the domain knowledges with this each user is associated and the interrelationships between the domains. For instance, John Doe 326 has knowledge in Domain A 343, Domain B 344, and Domain C 345 as illustrated at 350, 360, and 359, respectively. Bob Test has knowledge in Domain A 343 and Domain D 346 as illustrated at 351 and 352, respectively. Jane Doe 342 has knowledge in Domain C 345 and Domain F 348 as illustrated at 357 and 356, respectively. As noted, domains may be related to one another; for instance, Domain B 344 and Domain G 349 may be related, as illustrated at 358. Relations may include common users, overlapping subject matter, overlapping applications and/or overlapping tools, among others. Domain A 343 may be related to Domain C, as illustrated at 354, and Domain B 344 may be related to Domain E 347, as illustrated at 353. More or fewer interrelationships between domains may be possible. Interrelationship information can be used to find direct and indirect relations between users. For instance, users with knowledge in related domains may have similar domain knowledges.

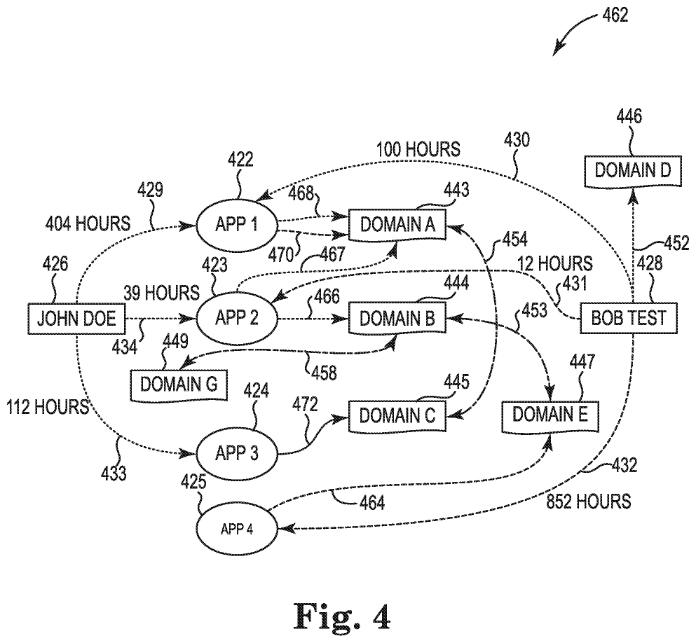

FIG. 4 illustrates a mapping 462 of user application usage and domain knowledge according to an example. Using the applications used and the usage time, the insights and relationships extracted from captured communication telemetry data, and relationships between different data sets, the mapping 462 can be produced to illustrate domain knowledges and application knowledge levels. For instance, the mapping 462 illustrates user John Doe 426 has interacted with a first application 422 for 404 hours as illustrated at 429 and used the first application 422 on tasks related to Domain A 443, as illustrated at 468. John Doe 426 has interacted with a second application 423 for 39 hours as illustrated at 434 and used the second application 423 on tasks related to Domain B 444, as illustrated at 466 and Domain A 443, as illustrated at 467. John Doe 426 has interacted with a third application 424 for 312 hours, as illustrated at 433, and used the third application 424 for tasks related to Domain C 445, as illustrated at 472.

User Bob Test 428 has interacted with the first application 422 for 100 hours as illustrated at 430 and used the first application 422 on tasks related to Domain A 443, as illustrated at 470. Bob Test 428 interacted with the second application 423 for 12 hours as shown at 431, but he did not use the second application 423 on a domain identified in the mapping 462, Bob Test 428 interacted with the fourth application 425 for 852 hours, as shown at 432, and he used the fourth application 425 to interact with Domain E 447, as illustrated at 464. Bob Test 428 also has domain knowledge with respect to Domain D 446, as illustrated at 452, but the mapping 462 does not indicate an application used in relation to Domain D 446.

Using the mapping 462, determinations can be made, for instance determining John Doe 426 is the most experienced user of the first application 422 and John Doe 426 knows about Domain A 443. Other examples include using the mapping 462 to determine John Doe 426 used different applications (e.g., the first application 422 and the third application 424) on tasks related to different domains (e.g., Domain A 443 and Domain C 455), even though Domain A 443 and Domain C 455 are related, as illustrated at 454. Additionally, while neither John Doe 426 nor Bob Test 428 knows about Domain E 447, Bob Test knows about Domain B 444, which is related to Domain E 447, as illustrated at 453. Such insights can be used by an organization to build teams based on domain knowledge (e.g., research and development teams, etc.) or determine domains where hiring may be beneficial (e.g., due to lack of users with a particular domain knowledge).

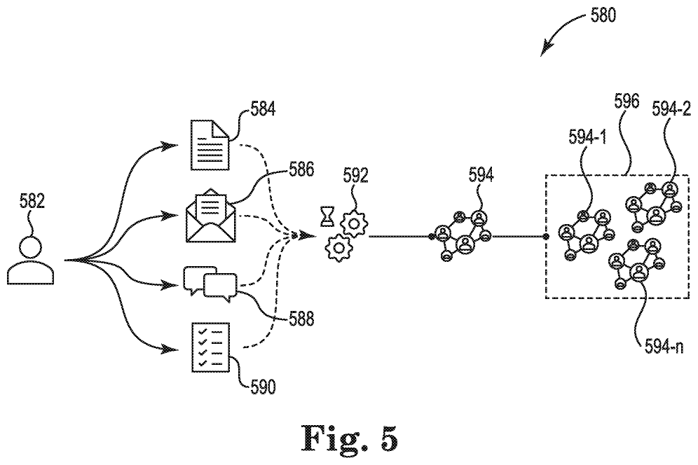

FIG. 5 illustrates a method 580 for determining user domain knowledge according to an example. Data captured by a provider on a computing device that is associated with a predefined list of applications and tools can be stored and processed. For instance, when a user 582 is creating content to a word processing application, email application, messaging application, or other application (e.g., spreadsheet application, software development tool, IDE, etc.), the telemetry data associated with the content can be stored and used to determine domain knowledge of the user 582.

For example, the user 582 can create content using a word processing application 584, sending an e-mail message 586, sending an instant message 588, or using a note-taking application 590, among others. The content that is added to each of the applications 584, 586, 588, 590 can be stored for later processing, and used to extract insights and relationships at 592, for instance using a learning model such as AI models and techniques including machine learning models. These insights and relationships can be used to map 594 the domain knowledge of the user 582. Other user maps 594-1, 594-2, 594-n can be gathered at 596 to produce an interconnected domain knowledge graph network. The interconnected domain knowledge graph network, for instance can cover an entire organization, selected areas of the organization, particular business units, and/or individual teams, among others.

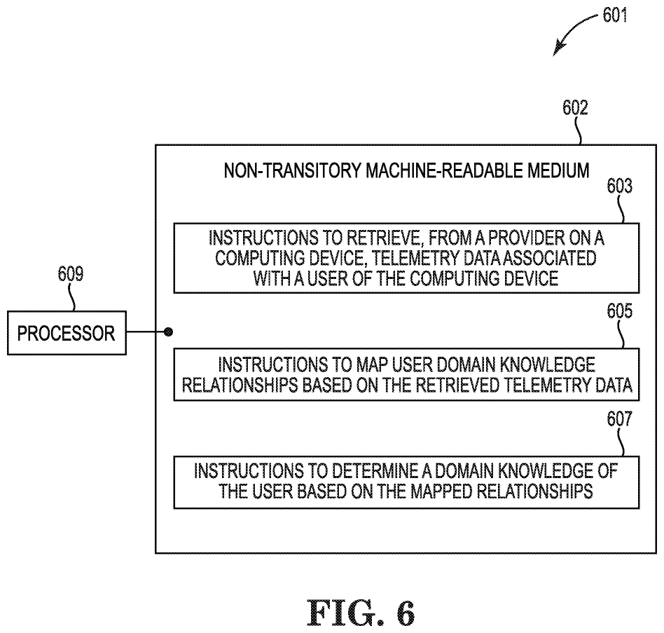

FIG. 6 illustrates another system 601 for determining user domain knowledge including a processor 609 and a non-transitory machine-readable medium (MRM) 602. System 601 can be a server or a computing device (among others) in some examples and can include the processor 609. System 601 can further include the non-transitory MRM 602, on which may be stored instructions, such as instructions 603, 605, and 607, Although the following descriptions refer to a processor and a memory resource, the descriptions may also apply to a system with multiple processors and multiple memory resources. In such examples, the instructions may be distributed (e.g., stored) across multiple non-transitory MRMs and the instructions may be distributed (e.g., executed by) across multiple processors.

The non-transitory MRM 602 may be electronic, magnetic, optical, or other physical storage device that stores executable instructions. Thus, non-transitory MRM 602 may be, for example, Random Access Memory (RAM), an Electrically-Erasable Programmable ROM (EEPROM), a storage drive, an optical disc, and the like. The non-transitory MRM 602 may be disposed within a controller and/or computing device. In this example, the executable instructions 603, 605, and 607 can be “installed” on the device. Additionally and/or alternatively, the non-transitory MRM 602 can be a portable, external or remote storage medium, for example, that allows the system 601 to download the instructions 603, 605, and 607 from the portable/external/remote storage medium. In this situation, the executable instructions may be part of an “installation package”. As described herein, the non-transitory MRM 602 can be encoded with executable instructions for determining user domain knowledge.

The instructions 603, when executed by a processor such as the processor 609, can include instructions to retrieve, from a provider on a computing device, telemetry data associated with a user of the computing device. This can include, for instance, data associated with the usage of the application and tools, as well as its contents. For instance, the retrieved telemetry data can include application telemetry data associated with the user and/or communication telemetry data associated with the user. This can include, for instance, data associated with the usage of the application and tools, as well as its contents, Application telemetry data can include data produced while a user is interacting with the application (e.g., using a word processing application, using a pdf application, etc.). The application telemetry data can include an amount of time the user interacted with a particular application. The communication telemetry data can include data retrieved from inspections executed on top of text contents exchanged through the use of the applications (e.g., email, instant messaging, etc.). In some examples, application and communication telemetry data are gathered from a predetermined list of applications. For instance, if an organization wants to collect data from organization-owned applications (e.g., excluding personal email, personal messaging, etc.).

The instructions 605, when executed by a processor such as the processor 609, can include instructions to map user domain knowledge relationships based on the retrieved telemetry data. For instance, using the retrieved application and communication data, a mapping can be created that includes how long a user used an application with respect to a particular domain based on interaction time or communication about the particular domain. The instructions 607, when executed by a processor such as the processor 609, can include instructions to determine a domain knowledge of the user based on the mapped relationships. For example, the non-transitory MRM 602 can include instructions to use AI models to determine the user domain knowledge relationships. This can include tracking how the user interacts with a particular application of the telemetry data, what content is inserted against the particular application, and what content is used against each application. For example, data associated with how a user interacts with the particular application and how long the user interacts are collected and observed as two datasets, which can be correlated to determine a user's domain knowledge

In some examples, based on an amount of time a user interacted with a particular application with respect to a particular domain, a determination of the user's domain knowledge can be determined. For instance, if a user interacted with a first application for tasks related to a first domain for the majority of the user's workday, it may be determined the user has a high domain knowledge with respect to that domain as compared to other with lower interaction times.

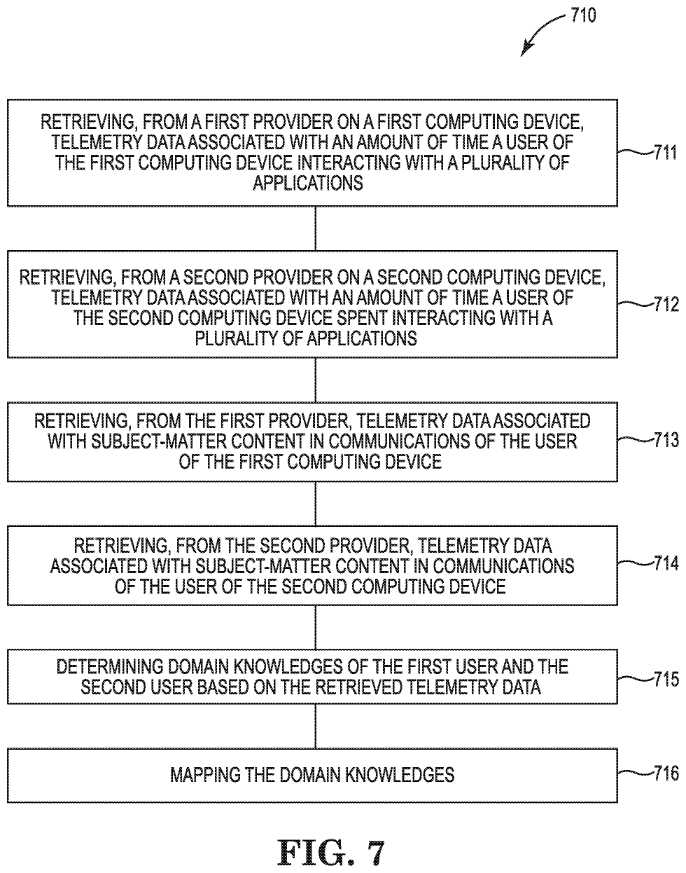

FIG. 7 illustrates a method 710 for determining user domain knowledge according to an example. The method 710 may be performed by a system 601 and/or a controller 102 as described with respect to FIGS. 1 and 6. At 711, the method 710 includes retrieving, from a first provider on a first computing device, telemetry data associated with an amount of time a user of the first computing device interacting with a plurality of applications and at 712, retrieving, from a second provider on a second computing device, telemetry data associated with an amount of time a user of the second computing device spent interacting with a plurality of applications. Using the retrieved data, a knowledge level of the user of the first computing device and a knowledge level of the user of the second computing device with respect to a particular one of the plurality of applications can be determined based on the time spent interacting with the particular one of the plurality of applications. For example, if the first user interacted with the particular application for 12 hours on a task related to a particular domain, and the second user interacted with the particular application for 200 hours on a task related to the particular domain, it may be determined that the second user has a greater knowledge level with respect to the particular application, and potentially the particular domain.

At 713, the method 710 includes retrieving, from the first provider, telemetry data associated with subject-matter content in communications of the user of the first computing device, and at 714 retrieving, from the second provider, telemetry data associated with subject-matter content in communications of the user of the second computing device. The subject matter contents, for example, can include topics and/or domain information extracted from the communication and/or associated application or other applications (e.g., messages, emails, texts, images, etc.). In some instances, this telemetry data is retrieved from the first and the second users associated with subject-matter content in communication between users within a particular network. For instance, the particular network may include an organizational network or same environment. For instance, an organization may have a plurality of physical locations (e.g., different offices, different states, different countries, etc.) from which data is gathered.

Limiting the retrieved communication telemetry data to within an organization may be done to prevent privacy issues. For instance, a user may use a work-issued laptop to compose personal emails. Content from those emails may not be analyzed for domain content, rather content-directed tools and applications (e.g., private email, password field, other personal means tools, etc.) may be filtered out from being subject to data collection or monitoring by a provider.

At 715, the method 710 includes determining domain knowledges of the first user and the second user based on the retrieved telemetry data. Using the application and communication data, a user's knowledge of a particular domain can be determined, and at 716, the domain knowledges can be mapped. In some examples, domain knowledges can be correlated based on the mapping. By correlating domain knowledges of a user or a plurality of users, insights can be determined with respect to what the users know, and where certain domain knowledges may be lacking. Organizations may use such data, for instance, to fill gaps in employees with desired domain knowledges and/or build teams based on domain knowledges, for example.

The method 710 can allow an organization to identify subject matter experts and create a mapping (e.g., a graph) including connections between users, domains, and used applications and/or tools. Such content can be used, for instance, to map the organization and help to better allocate resources throughout different projects and areas inside the organization.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. Further, as used herein, “a number of” an element and/or feature may refer to one or more of such elements and/or features.

What is claimed is:

1. A non-transitory machine-readable medium having instructions that when executed by a processor cause the processor to:
retrieve, from a provider on a computing device, telemetry data associated with a user of the computing device;
map user domain knowledge relationships based on the retrieved telemetry data; and
determine a domain knowledge of the user based on the mapped relationships.

2. The medium of claim 1, further comprising the instructions executed to retrieve application telemetry data associated with an application with which the user interacts.

3. The medium of claim 1, further comprising the instructions executed to retrieve communication telemetry data associated with the user.

4. The medium of claim 1, further comprising the instructions executed to retrieve telemetry data associated with an amount of time the user interacted with a particular application.

5. The medium of claim 1, further comprising the instructions executed to use an artificial intelligence (AI) model to determine the user domain knowledge relationships.

6. The medium of claim 1, further comprising the instructions executed to track how the user interacts with a particular application of the telemetry data, what content is inserted against the particular application, and what content is used against each application.

7. A system, comprising:
a plurality of providers located on each one of a respective plurality of computing devices, each one of the plurality of providers to collect a plurality of application telemetry data associated with a user of the respective one of the plurality of computing devices; and
a controller coupled to each one of the plurality of providers to:
determine a knowledge level of each one of the users with respect o each one of a plurality of applications of the plurality of application data;
determine a domain knowledge of each one of the users of the respective one of the plurality of computing devices based on the knowledge levels; and
determine domain knowledge relationships between different users of the plurality of computing devices based on the determined knowledge levels and determined domain knowledges.

8. The system of claim 7, further comprising the controller to determine the knowledge level of each one of the users based on an amount of time the user spends interacting with the application.

9. The system of claim 7, further comprising each one of the plurality of providers to collect a plurality of communication telemetry data associated with the respective user of the respective one of the plurality of computing devices.

10. The system of claim 7, further comprising the controller to map the determined domain knowledge relationships.

11. The system of claim 7, further comprising each one of the plurality of providers to continuously collect the plurality of application telemetry data and periodically report it to the controller for retrieval.

12. A method, comprising:
retrieving, from a first provider on a first computing device, telemetry data associated with an amount of time a user of the first computing device interacting with a plurality of applications;
retrieving, from a second provider on a second computing device; telemetry data associated with an amount of time a user of the second computing device spent interacting with a plurality of applications;
retrieving, from the first provider, telemetry data associated with subject-matter content in communications of the user of the first computing device;
retrieving, from the second provider, telemetry data associated with subject-matter content in communications of the user of the second computing device;
determining domain knowledges of the first user and the second user based on the retrieved telemetry data; and
mapping the domain knowledges.

13. The method of claim 12, further comprising:
determining a knowledge level of the user of the first computing device with respect to a particular one of the plurality of applications based on the time spent interacting with the particular one of the plurality of applications; and
determining a knowledge level of the user of the second computing device with respect to the particular one of the plurality of applications based on the time spent interacting with the particular one of the plurality of applications.

14. The method of claim 12, further comprising retrieving telemetry data from the first and the second users associated with subject-matter content in communication between users within a particular network.

15. The method of claim 12, further comprising correlating domain knowledges based on the mapping.
